(19) United States
(12) Patent Application Publication
(10) Pub. No.: US 2014/0282730 A1
(43) Pub. Date: Sep. 18, 2014

(54) VIDEO PREVIEW WINDOW FOR AN ELECTRONIC PROGRAM GUIDE RENDERED BY A VIDEO SERVICES RECEIVER

(71) Applicant: ECHOSTAR TECHNOLOGIES L.L.C., Englewood, CO (US)

(72) Inventor: Eric Hieb, Parker, CO (US)

(73) Assignee: ECHOSTAR TECHNOLOGIES L.L.C., Englewood, CO (US)

(21) Appl. No.: 13/804,235

(22) Filed: Mar. 14, 2013

(51) Int. Cl. H04N 21/431; H04N 21/482

(52) U.S. Cl. CPC H04N 21/4316; H04N 21/482
USPC 725/41; 725/43

(57) ABSTRACT

A video services receiver as presented herein has a display element operatively associated therewith. The receiver is operated to provide primary content for presentation on the display element, and to provide an interactive electronic program guide (EPG) for presentation on the display element concurrently with the primary content. The EPG has entries corresponding to listed program events. The operating method for the receiver continues by detecting focus of one of the entries to obtain a selected program event, generating a preview window for presentation on the display element concurrently with the primary content and concurrently with at least a portion of the interactive EPG, and providing secondary content in the preview window. The secondary content is associated with the selected program event.

### TECHNICAL FIELD

Embodiments of the subject matter described herein relate generally to video services systems. More particularly, embodiments of the subject matter relate to systems and methods for controlling the presentation of preview content for program events listed in an electronic program guide.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

In addition to receiving and demodulating video content (such as television programming), many video services receivers are able to provide additional features. Examples of popular features available in many modern video services receivers include electronic program guides (EPGs), digital video recorders (DVRs), “place-shifting” features for streaming received content over a network or other medium, and/or the ability to simultaneously view multiple programs showing on different channels using picture-in-picture (PIP) functionality.

Many conventional STBs are designed to generate and present program search menus and/or EPGs for graphical rendering on a display element, such as a television or a monitor. The user can navigate onscreen guides or menus to identify or select a program, to set system preferences, to control recording and/or playback of video content, etc. Traditional EPGs may provide a brief written description of each listed program event, which may include the title of the program, the network channel, a genre label, a content rating, a plot summary, or the like. Although EPGs are commonly utilized, there nevertheless remains a desire to improve the usability and feature set associated with EPGs.

It is therefore desirable to create systems and methods that improve the manner in which visual content is presented to the user of an EPG generated by a video services receiver. Such improvements, along with other desirable features and characteristics related to a video services system, will become apparent from the subsequent detailed description and the appended claims, taken in conjunction with the accompanying drawings and this background section.

### BRIEF SUMMARY

A method of operating a video services receiver having a display element operatively associated therewith is presented here. The method provides primary content for presentation on the display element, and provides an interactive electronic program guide (EPG) for presentation on the display element concurrently with presentation of the primary content. The interactive EPG includes a plurality of entries corresponding to a plurality of listed program events. The method may continue by detecting focus of one of the plurality of entries to obtain a selected program event, generating a preview window for presentation on the display element concurrently with presentation of the primary content and concurrently with presentation of at least a portion of the interactive EPG, and providing secondary content in the preview window. The secondary content is associated with the selected program event.

A video services receiver is also presented here. The receiver includes a receiver interface to receive data associated with video services, a display interface for a display element operatively coupled to the video services receiver, and a processor architecture having at least one processor device. The display interface facilitates presentation of video content on the display element, and the processor architecture cooperates with the receiver interface and the display element to provide primary video content for presentation in a first area of the display element, and to provide an interactive EPG for presentation in a second area of the display element concurrently with the primary video content. The receiver is operated to generate a preview window for presentation on the display element concurrently with the interactive EPG and the primary video content, wherein the preview window includes secondary content that is contextually related to a selected program event in the interactive EPG.

Also presented is a method of operating a video services receiver having a display element operatively associated therewith. The method involves providing an interactive EPG for presentation on the display element, wherein the interactive EPG has a plurality of entries corresponding to a plurality of listed program events. The method may continue by detecting focus of one of the plurality of entries to obtain a selected program event, generating a preview window for presentation on the display element concurrently with presentation of at least a portion of the interactive EPG, and providing secondary content for presentation in the preview window. The secondary content is contextually related to the selected program event.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services broadcasting system;

FIG. 2 is a simplified schematic representation of an embodiment of a video services receiver device suitable for use in the system shown in FIG. 1;

FIG. 3 is a flow chart that illustrates an embodiment of an EPG preview process; and

FIGS. 4-8 are renditions of exemplary display screens that could be generated by a video services receiver for presentation on a display element.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The exemplary embodiments described below relate to a video delivery system such as a satellite television system. The disclosed subject matter relates to the presentation of secondary visual content (for example, video content, audiovisual content, still images, graphics, or the like) in connection with the display of an interactive EPG on a display element, wherein the visual content is related to a program event that is listed in the EPG. For example, the secondary visual content may be a video clip preview of an upcoming program event that will be broadcast at some time in the future. As another example, the secondary visual content may be a live concurrent presentation of a program event that is currently being broadcast on another channel. The techniques and methodologies described herein allow a user of a video services receiver to continue watching one program (primary video content) while traversing the EPG to preview other programs listed in the EPG.

Turning now to the drawings, FIG. 1 is a schematic representation of an embodiment of a video services broadcasting system 100 that is suitably configured to support the techniques and methodologies described in more detail below. The system 100 (which has been simplified for purposes of illustration) generally includes, without limitation: a data center 102; an uplink transmit antenna 104; a satellite 106; a downlink receive antenna 108; a video services receiver 110 or other customer equipment; and a presentation device, such as a display element 112. In typical deployments, the video services receiver 110 can be remotely controlled using a wireless remote control device 113. In certain embodiments, the data center 102 communicates with the video services receiver 110 via a back-channel connection 114, which may be established through one or more data communication networks 116. For the sake of brevity, conventional techniques related to satellite communication systems, satellite broadcasting systems, DVB systems, data transmission, signaling, network control, and other functional aspects of the systems (and the individual operating components of the systems) may not be described in detail herein.

The data center 102 may be deployed as a headend facility and/or a satellite uplink facility for the system 100. The data center 102 generally functions to control content, signaling data, programming information, and other data sent over a high-bandwidth link 118 to any number of downlink receive components (only one downlink receive antenna 108, corresponding to one customer, is shown in FIG. 1). In practice, the data center 102 also provides content and data that can be used to populate an interactive electronic program guide (EPG) generated by the video services receiver 110. In the embodiment shown in FIG. 1, the high-bandwidth link 118 is a direct broadcast satellite (DBS) link that is relayed by the satellite 106, although equivalent embodiments could implement the high-bandwidth link 118 as any sort of cable, terrestrial wireless and/or other communication link as desired.

The data center 102 includes one or more conventional data processing systems or architectures that are capable of producing signals that are transmitted via the high-bandwidth link 118. In various embodiments, the data center 102 represents a satellite or other content distribution center having: a data control system for controlling content, signaling information, blackout information, programming information, and other data; and an uplink control system for transmitting content, signaling information, blackout information, programming information, and other data using the high-bandwidth link 118. These systems may be geographically, physically and/or logically arranged in any manner, with data control and uplink control being combined or separated as desired.

The uplink control system used by system 100 is any sort of data processing and/or control system that is able to direct the transmission of data on the high-bandwidth link 118 in any manner. In the exemplary embodiment illustrated in FIG. 1, the uplink transmit antenna 104 is able to transmit data to the satellite 106, which in turn uses any number of appropriately configured transponders for repeated transmission to the downlink receive antenna 108.

Under normal operating conditions, the satellite 106 transmits content, signaling data, blackout information, EPG data, and other data to the downlink receive antenna 108, using the high-bandwidth link 118. In practical embodiments, the downlink receive antenna 108 represents the customer's satellite dish, which is coupled to the video services receiver 110. The video services receiver 110 can be realized as any device, system or logic capable of receiving signals via the high-bandwidth link 118 and the downlink receive antenna 108, and capable of providing demodulated content to a customer via the display device 112.

The display device 112 may be, without limitation: a television set; a monitor; a computer display; or any suitable customer appliance with compatible display capabilities. In various embodiments, the video services receiver 110 is implemented as a set-top box (STB) as commonly used with DBS or cable television distribution systems. In other embodiments, however, the functionality of the video services receiver 110 may be commonly housed within the display device 112 itself. In still other embodiments, the video services receiver 110 is a portable device that may be transportable with or without the display device 112. The video services receiver 110 may also be suitably configured to support broadcast television reception, video game playing, personal video recording and/or other features as desired.

During typical operation, the video services receiver 110 receives programming (broadcast events), signaling information, and/or other data via the high-bandwidth link 118. The video services receiver 110 then demodulates, decompresses, descrambles, and/or otherwise processes the received digital data, and then converts the received data to suitably formatted video signals 120 that can be rendered for viewing by the customer on the display device 112. The video services receiver 110 may also be capable of receiving web-based content via the network 116, the Internet, etc. Additional features and functions of the video services receiver 110 are described below with reference to FIG. 2.

The system 100 includes one or more speakers, transducers, or other sound generating elements or devices that are utilized for playback of sounds during operation of the system 100. These sounds may be, without limitation: the audio portion of a video channel or program; the content associated with an audio-only channel or program; audio related to the navigation of the graphical programming guide; confirmation tones generated during operation of the system; alerts or alarm tones; or the like. Depending upon the embodiment, the system 100 may include a speaker (or a plurality of speakers) attached to, incorporated into, or otherwise associated with the display device, the video services receiver 110, the remote control device 113, and/or a home theater, stereo, or other entertainment system provided separately from the system 100.

The video services receiver 110 can be operated in a traditional manner to receive, decode, and present a video program event as the primary video content (i.e., a show that the user is currently watching). Such primary video content is usually presented and viewed in a full screen mode with little to no additional video content. The user, however, may launch an interactive EPG to view listings for other programming (which may be program events that are currently being broadcast along with the primary video content, upcoming program events that are to be broadcast in the future, or program events that have already occurred). Basic EPG functionality and features are commonly utilized by a variety of video services systems, and such functionality and features will not be described in detail here.

In accordance with certain embodiments, the user of the video services receiver 110 can select, hover over, or otherwise focus on the entries of the EPG to obtain additional information or data associated with the selected program event. For example, selecting an entry for a particular program event may cause the video services receiver 110 to present additional information that describes the content of the selected program event. In accordance with the exemplary embodiments described herein, focusing on or selecting an entry for a given program event facilitates the presentation of secondary content that is linked to the selected program event. More specifically, a preview window is generated for purposes of rendering secondary content that is somehow related to the selected program event. Notably, the secondary content in the preview window can be presented concurrently with the primary video content, such that the viewer can continue watching the current program event in an uninterrupted manner while perusing other video content that might be currently available on other channels.

FIG. 2 is a schematic representation of an embodiment of a video services receiver 200 suitable for use in a video services broadcasting system, such as the system 100 shown in FIG. 1. In this regard, the video services receiver 200 may represent one suitable embodiment of the video services receiver 110 shown in FIG. 1. This particular embodiment generally includes, without limitation: a receiver interface 208, a plurality of decoder modules 214, and a display processor module 218, as appropriate. FIG. 2 also shows a disk controller interface 206 to a disk or other storage device 207, a network interface 210 to a local or wide area network, a transport select module 212, a display interface 228 for a display element, an RF receiver module 232, and a controller 205, which may be implemented as control logic executed by a processor architecture. Other embodiments may incorporate additional or alternate processing modules from those shown in FIG. 2, may omit one or more modules shown in FIG. 2, and/or may differently organize the various modules in any other manner different from the exemplary arrangement shown in FIG. 2.

The video services receiver 200 may be physically and logically implemented in any manner. FIG. 2 shows various logical and functional features that may be present in an exemplary device, wherein each module shown in the figure may be implemented with any sort of hardware, software, firmware, and/or the like. In this regard, the video services receiver 200 may include a processor architecture having at least one processor device that cooperates with the various modules, elements, and devices of the video services receiver 200 to support the features and functions described herein. Any of the various processing modules may be implemented with any sort of general or special purpose integrated circuitry, for example, such as any sort of microprocessor, microcontroller, digital signal processor, programmed array and/or the like. Any number of the modules shown in FIG. 2, for example, may be implemented as a “system on a chip” (SoC) using any suitable processing circuitry under control of the controller 205. In various embodiments, the control logic of the controller 205 executes within an integrated SoC or other processor that implements the receiver interface 208, the transport select module 212, the decoder module 214, the display processor module 218, the disk controller interface 206, and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be interconnected with each other to implement the receiving and decoding functions represented in FIG. 2.

Various embodiments of the video services receiver 200 therefore include any number of appropriate modules for obtaining and processing media content (which may include video content, audio content, audiovisual content, still images, graphics, advertisements, posters or screens related to program events, or the like) as desired for the particular embodiment. Each of these modules may be implemented in any combination of hardware and/or software using logic executed within any number of semiconductor chips or other processing logic.

Various embodiments of the controller 205 can include any circuitry, components, hardware, software and/or firmware logic capable of controlling the various components of the video services receiver 200. Various routines, methods and processes executed within the video services receiver 200 are typically carried out under the control of the controller 205, as described more fully below. Generally speaking, the controller 205 receives user input signals via the RF receiver module 232, which in turn communicates with the remote control device 113 (see FIG. 1) using a suitable antenna 234. The controller 205 receives user inputs from the remote control device 113 and/or any other source, and directs the other components of the video services receiver 200 in response to the received inputs to present the desired imagery on a display element.

As noted above, many embodiments of the video services receiver 200 include a receiver interface 208, which is any hardware, software, firmware and/or other logic capable of receiving data associated with video services (e.g., media content data) via one or more content sources 240. In various embodiments, the content sources 240 may include any number of cable television, DBS, broadcast and/or other programming sources as appropriate. Although not separately depicted in FIG. 2, the receiver interface 208 may include or cooperate with a plurality of tuners that are configured to receive the content data from the content sources 240. For example, in a satellite video system, the receiver interface 208 may include a plurality of tuners to enable the video services receiver 200 to receive data from a plurality of satellite transponders.

The receiver interface 208 appropriately selects a desired input source and provides the received content to an appropriate destination for further processing. In various embodiments, received programming may be provided in real-time (or near real-time) to a transport select module 212 or other component for immediate decoding and presentation to the user. Alternatively, the receiver interface 208 may provide content received from any source to a disk or other storage medium in embodiments that provide DVR functionality. In such embodiments, the video services receiver 200 may also include a disk controller interface 206 that interacts with an internal or external hard disk, memory and/or other storage device 207, which may be suitably configured to store recorded video content in an appropriate database structure.

In the embodiment shown in FIG. 2, the video services receiver 200 also includes an appropriate network interface 210, which operates using any implementation of protocols or other features to support communication by the video services receiver 200 on a network. In various embodiments, the network interface 210 supports conventional LAN, WAN or other protocols (e.g., the TCP/IP or UDP/IP suite of protocols widely used on the Internet) to allow the video services receiver 200 to communicate on the Internet or any other network as desired. The network interface 210 typically interfaces with the network using any sort of LAN adapter hardware, such as a conventional network interface card (NIC) or the like provided within the video services receiver 200.

The transport select module 212 is any hardware and/or software logic capable of selecting a desired media stream from the available sources. In the embodiment shown in FIG. 2, the transport select module 212 is able to generate video signals for presentation on one or more output display interfaces 228. Typically, the transport select module 212 responds to viewer inputs (e.g., via the controller 205) to simply switch encoded content received from a broadcast, satellite, cable or other content source 240 or from the storage device 207 to one or more decoder modules 214.

The video services receiver 200 may include a plurality of decoder modules 214 for decoding, decompressing, and/or otherwise processing received/stored content as desired. Generally speaking, the decoder modules 214 decompress, decode, and/or otherwise process received content from the transport select module 212 to extract an MPEG or other media stream encoded within the stream. The decoded content can then be processed by one or more display processor modules 218 to create a presentation on a display element for the viewer in any appropriate format. FIG. 2 shows two decoder modules 214A, 214B operating on two separate signals from the transport select module 212. The two decoder modules 214A, 214B allow the video services receiver 200 to provide and present two distinct and separate video streams concurrently on one display element. In practice, any number of decoder modules 214 may be used, particularly in situations where multiple signals are simultaneously decoded and displayed. Accordingly, the term “decoder” may collectively apply to one or more decoder modules that are able to decode one or more signals for presentation on the display element. As described in more detail below, the decoder module 214A could be used to decode the primary video content that represents a currently viewed video program event, and the decoder module 214B could be used to decode secondary video content that is rendered in a preview window of an EPG (or vice versa). For such a scenario, the primary video content may correspond to a first broadcast event that is currently available on a first channel or service, and the secondary video content may correspond to a second broadcast event that is currently available on a different channel or service.

The display processor module 218 includes any appropriate hardware, software and/or other logic to create desired screen displays via the display interface 228 as desired. Such displays may include combining signals received from one or more of the decoder modules 214 to facilitate presentation and viewing of one or more channels of video content on a display element. In various embodiments, the display processor module 218 is also able to produce on screen displays (OSDs) for an interactive EPG, setup and control functions, input/output facilitation, and/or other features that may vary from embodiment to embodiment. Such graphical displays are not typically contained within the received or stored broadcast stream, but are nevertheless useful to users in interacting with the video services receiver 200. The generated displays, including received/stored content and any other displays may then be presented to one or more output display interfaces 228 in any desired format.

When the viewer requests display of an EPG preview window, for example, the display processor module 218 may be operable to receive the desired imagery from one or more of the decoder modules 214 (or from the storage device 207) and to create visual content for presentation in the EPG preview window, while concurrently presenting primary video content in a different area of the display element. As the video services receiver 200 receives user input signals from the remote control device 113, the controller 205 may direct the display processor module 218 to initiate, terminate, or change the secondary video content presented in the EPG preview window as directed by the viewer. The display processor module 218 therefore directs the presentation of the primary and secondary video content in conjunction with one or more user commands (e.g., navigation of an interactive EPG).

The display processor module 218 produces an output signal encoded in any standard format (e.g., ITU656 format for standard definition television signals or any format for high definition television signals) that can be readily converted to standard and/or high definition television signals at the display interface 228. In other embodiments, the functionality of the display processor module 218 and the display interface 228 may be combined in any manner.

FIG. 3 is a flow chart that illustrates an embodiment of an EPG preview process 300, and FIGS. 4-8 are renditions of exemplary display screens that could be generated by a video services receiver for presentation on a display element. The various tasks performed in connection with the process 300 may be performed by software, hardware, firmware, or any combination thereof. For illustrative purposes, the following description of the process 300 may refer to elements mentioned above in connection with FIGS. 1, 2, and 4-8. In practice, portions of the process 300 may be performed by different elements of the described system, e.g., a processor architecture, a display interface, a display processor, a transport selector, or the like. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 represents one exemplary embodiment of a method of operating a video services receiver having a display element operatively associated therewith, wherein the video services receiver provides and presents visual content (still image content, graphics content, video content, etc.) for viewing on the display element. The illustrated embodiment of the process 300 begins by operating the video services receiver to provide primary content for presentation on the display element (task 302). The corresponding audio content (if any) of the primary content will be also be generated using the audio playback equipment associated with the video services receiver, in accordance with conventional playback methodologies. Although the primary content could be a still image, a splash screen, a simple graphic, or the like, this description assumes that the primary content includes video content, such as a live (unrecorded) broadcast program event, recorded video content, streaming media content, or any type of video content that can be obtained and presented by the video services receiver, as described above with reference to FIG. 2. In accordance with this particular example, the primary content is a broadcast video program event (e.g., a network television show, a movie, or a sporting event) that is currently being received by the video services receiver in association with one channel or video service.

In most typical use cases, the user views the primary content in a default “full screen” mode, where most if not all of the display area of the display element is devoted to rendering the primary video content. This description, however, relates to a situation where the user has launched an interactive EPG to view a listing of additional program events. The EPG may be launched in any number of different ways. For example, the EPG could be launched in response to user interaction with a particular button or sequence of buttons on a remote control device, such as a “Guide” button. The EPG could also be reached by traversing one or more on-screen menus. As another example, the EPG could be activated by manipulating one or more buttons or other user interface elements on the video services receiver itself. Although not always required, the exemplary embodiment of the process 300 provides the interactive EPG for presentation on the display element concurrently with the presentation of the primary content (task 304).

In practice, the EPG and/or other programming data could be delivered to the host video services receiver during the normal scheduled broadcast of program events, or it could be delivered to the video services receiver prior to scheduled broadcasts. For example, EPG data could be sent to the video services receiver using one or more overhead signaling and/or control channels. The manner in which the video services receiver obtains this information is unimportant for purposes of this description, and the specific data transmission methodology may vary from one deployment to another.

During operation of the video services receiver, the process 300 can be used to generate and provide an appropriately formatted and configured interactive EPG for display on the display element. This example assumes that the process 300 provides a GUI in the form of a graphical interactive programming interface for video services (task 304). In this regard, FIG. 4 is a rendering of one exemplary display screen 400 that includes an interactive EPG 402 having a plurality of user-selectable or user-focusable elements. The illustrated embodiment of the display screen 400 generally includes, without limitation: a date/time field 404; a first video presentation area 406; a program description area 408; and a program list window 410. All of these items could be considered to be part of the interactive EPG 402.

For this embodiment, the date/time field 404 includes text that identifies the current day (e.g., Thursday), the current date (e.g., October 4), and the current time (e.g., 6:11 PM). The first video presentation area 406 represents a viewing window that accommodates the presentation of the primary content 412 in an ongoing and uninterrupted manner. Although FIG. 4 depicts the first video presentation area 406 as a relatively small and compact window, the shape, size, aspect ratio, and/or position of the first video presentation area 406 may vary from one embodiment to another, and may be user-configurable in certain implementations.

The program description area 408 may be used to provide additional information or data for a particular program event. In some situations, the program description area 408 could be used to provide descriptive information regarding the current primary content. In response to user interaction with the program listings, however, the program description area 408 may be updated with descriptive information regarding a currently selected or a currently focused entry in the program list window. For example, the program description area 408 could be used to indicate (in text), without limitation: the designated time slot of the program; the title or name of the program; the rating (or other classification or category) of the program; a brief summary or abstract related to the content of the program; etc.

The program list window 410 may be used to indicate programming associated with different available video services. In practice, the program list window 410 will typically include a plurality of different entries corresponding to a plurality of listed program events. It should be appreciated that the program list window 410 need not (and usually will not) include all of the available program events, due to practical display space limitations. FIG. 4 specifically identifies entries for three different program events: an entry 414 for the show “Chopped”; an entry 416 for the show “Project Runway”; and an entry 418 for the show “House Hunters”. For this example, the show “Chopped” represents the currently presented primary content 412. Accordingly, the first video presentation area 406 is utilized to present the video for the show “Chopped”.

In typical implementations, the program list window 410 will include alphanumeric characters that identify certain time slots (which may be scrollable such that the user can view programming for different days/times), along with the different programs offered during those time slots. The program list window 410 may also include text, graphics, and/or logos that identify the different channels, networks, program events, or the like.

The display screen 400 shown in FIG. 4 represents a common format for an interactive EPG that occupies most of the display area. In contrast, FIG. 5 is a rendering of another exemplary display screen 500 that includes an interactive EPG 502 configured as a browse banner positioned at or near the bottom of the display screen 500. In alternative embodiments, the EPG 502 could be positioned elsewhere on the display screen 500. The EPG 502 can be superimposed over the primary content 504 such that the viewer can continue watching the primary content 504 in a large format rather than in a smaller window. In certain embodiments, the EPG 502 may be rendered with some transparency such that the underlying primary content 504 shows through the EPG 502.

The illustrated embodiment of the display screen 500 may include, without limitation: an upper banner area 508; and a lower banner area 510 that accommodates the EPG 502. The upper banner area 508 may be used to provide additional information or data for a particular program event. In some situations, the upper banner area 508 could be used to provide descriptive information regarding the current primary content 504. In response to user interaction with the program listings, however, the upper banner area 508 may be updated and populated with descriptive information regarding a currently selected or a currently focused entry in the EPG 502. For example, the upper banner area 508 could be used to indicate (in text), without limitation: the designated time slot of the program; the title or name of the program; the rating (or other classification or category) of the program; a brief summary or abstract related to the content of the program; etc. In certain embodiments, the upper banner area 508 may be rendered with some amount of transparency such that the underlying primary content 504 can still be viewed (although partially obscured by the text in the upper banner area 508). For clarity and ease of illustration, this transparency effect is not depicted in FIG. 5.

The lower banner area 510 can include the EPG 502. In certain embodiments, the lower banner area 510 may be rendered with some amount of transparency such that the underlying primary content 504 can still be viewed (although partially obscured by the text in the lower banner area 510). For clarity and ease of illustration, this transparency effect is not depicted in FIG. 5.

For this particular embodiment, the EPG 502 indicates programming associated with a selected channel or video service (e.g., TNT on channel 138). The user can change the selected channel or video service by manipulating a button or a sequence of buttons on a remote control device. Moreover, the user can adjust the EPG 502 to view programming at different time slots. In this regard, FIG. 5 depicts the EPG 502 in a state where only two program events are listed: an entry 514 for the show “Law & Order”; and an entry 516 for the show “The Mentalist”. In typical implementations, the EPG 502 will include descriptive information regarding the listed program events, such as the scheduled broadcast time slots, the selected channel, the selected network, the titles of the program events, the genre, a content rating, or the like.

FIG. 4 and FIG. 5 depict two possible implementations of an interactive EPG suitable for use with the operation of a video services receiver. It should be appreciated that the specific format and configuration of the interactive EPG that is generated and rendered in connection with the process 300 may differ from that shown in FIG. 4 and FIG. 5. Such modifications and variations are contemplated by this disclosure.

Referring back to FIG. 3, the process 300 may continue by operating the video services receiver to detect and respond to user interaction with the EPG (task 306). The interactive nature of the EPG allows the user to navigate the entries of the EPG using, for example, a remote control device to enter user-initiated commands such as: scrolling; up, down, left, right; select; enter; or the like. The exemplary embodiment of the process 300 detects focus (or user selection) of an entry in the EPG to obtain a selected program event (task 308). As used here, an element is “in focus” or is a “focused element” when it has been selected, has been highlighted, or is otherwise capable of being selected. A focused element could result in the automatic activation of a feature or an operation, or it could result in the display of additional information associated with the focused element. A focused element could also represent an element that is ready for activation via a user command or button-press. For example, as the user moves from entry to entry in the EPG, the currently selected or highlighted entry is considered to be in focus.

After an entry in the EPG is in focus, the process 300 may continue by generating a suitably formatted preview window for presentation on the display element (task 310). The preview window may be generated and displayed automatically in response to detecting focus of the EPG entry, or it may be generated after the process 300 receives a user-initiated preview command that is intended to launch the preview window. Automatic generation and population of the preview window may be delayed by a specified amount of time to accommodate a typical user workflow where EPG entries are quickly traversed. In this regard, the process 300 may automatically generate the preview window only after the EPG entry has remained in focus continuously for a designated amount of time, such as five seconds. User-initiated generation and population of the preview window may be associated with the activation of one or more buttons on a remote control device, such as a “Guide Preview” button.

In certain embodiments, the preview window is rendered and displayed on the display element concurrently with the presentation of the primary content and/or concurrently with at least a portion of the interactive EPG. This description assumes that the preview window, the primary content, and at least some of the interactive EPG are rendered and presented concurrently on the same display element. Such concurrent presentation allows the viewer to quickly and conveniently traverse the EPG while watching the primary content.

The preview window may be utilized to provide and present secondary (preview) content concurrently with the primary content, where the secondary content is somehow associated with the selected program event or is contextually related to the selected program event. For example, if the selected program event is a broadcast event that is currently available, then the secondary content may include the video portion of the currently available broadcast event. As another example, if the selected program event is an upcoming broadcast event that is scheduled to run in the future, then the secondary content may include a video preview of the upcoming broadcast event, a still image taken from the upcoming broadcast event, a poster or other graphic that identifies the upcoming broadcast event or the channel/network associated with the upcoming broadcast event, or any form of “alternative content” other than the selected program event itself. Moreover, such alternative content could be presented in the preview window even if the selected program event is currently being broadcast and is available for presentation in the preview window. Furthermore, alternative content could be presented in situations where the resources or capabilities of the video services receiver are limited or are otherwise unable to handle the presentation of the selected program event. For example, concurrent presentation of live secondary content may require a free tuner and/or a free decoder. If those resources are unavailable, then the video services receiver can present the alternative content.

Referring again to FIG. 3, the process 300 is designed to handle selected program events that are currently available and selected program events that are upcoming and scheduled to be broadcast in the future. Thus, if the selected or focused program event is a current broadcast event (query task 312), the process 300 may continue by providing and presenting the video content from the selected program event in the displayed preview window (task 314), assuming that the video services receiver has the appropriate resources available to receive, process, and decode the selected program event. The video for the selected program event is rendered and displayed in the preview window concurrently with the ongoing presentation of the primary content in a different area of the display element. Moreover, the process 300 may continue with the presentation of the primary audio track that corresponds to the primary content, while muting or otherwise inhibiting the playback of the audio track (if any) that accompanies the selected program event (task 316). In other words, the video services receiver presents a muted version of the selected program event so that the user can enjoy the primary content in an uninterrupted manner while previewing the secondary content. In alternative embodiments, of course, the audio track of the secondary content could be played in lieu of the primary audio track.

The illustrated embodiment of the process 300 supports user-initiated audio toggle commands that are intended to switch the audio tracks at the request of the user. Thus, if the process 300 receives a user-initiated audio toggle command for the selected program event (the “Yes” branch of query task 318), then the video services receiver responds by replacing the primary audio track with a secondary audio track that corresponds to the selected program event. In other words, the audio tracks are toggled (task 320) to enable the user to hear the audio that accompanies the secondary content displayed in the preview window.

Referring back to query task 312, if the selected or focused entry corresponds to an upcoming program event (or one that is not otherwise available for presentation in real time), then the process 300 may provide and present alternative secondary content for rendering in the preview window (task 322). Under these circumstances, the secondary content should be related to, contextually relevant to, or otherwise associated with the selected or focused entry. For example, the secondary content may include a preview video or a preview clip for the upcoming program event. In this regard, the secondary content may include a commercial, a teaser, or a trailer for the upcoming program event, or any available portion of the upcoming program event (which may be stored locally at the video services receiver or available for immediate downloading or streaming). As another example, the secondary content may include a graphic, an animated graphic, a picture, a screen cap, a tile, a poster, or any type of still image that identifies the upcoming broadcast event in some manner. In this regard, if the upcoming broadcast event is to be broadcast on a specified channel, then the secondary content may include a logo or other graphic that identifies the specified channel. Similarly, if the upcoming broadcast event is to be broadcast by a specified network or service, then the secondary content may include a logo or other graphic that identifies the specified network or service.

Although this description assumes that task 322 provides some form of contextually relevant information in the secondary content, an embodiment of the process 300 need not be limited to such content. Indeed, any type or form of secondary content could be rendered in the preview window in lieu of the actual selected program event. Likewise, even if the selected or focused program event is available for concurrent viewing, the preview window need not always present that available content. In this regard, there may be certain situations where the video services provider wishes to “push” content to the viewers by way of the preview window, or there may be certain situations where a graphic, a poster, or an advertisement is presented before playback of the selected program event begins. These and other scenarios are contemplated by this disclosure.

FIG. 6 is a rendering of a display screen 600 that may be rendered when a selected or focused program event in the EPG is currently available for presentation in the preview window. For this example, the display screen 600 includes the EPG 402 shown in FIG. 4 after the entry 416 for the show “Project Runway” has obtained focus. Focus of the entry 416 may be indicated by shading, coloring, highlighting, outlining, or by any technique that makes the entry 416 distinguishable from any non-focused item. FIG. 6 also shows an exemplary implementation of a preview window 602 displayed in association with the entry 416. Although not always required, the preview window 602 may include an arrow, a line, or some other visual indicator that links the preview window 602 to the focused entry 416. For this example, the preview window 602 includes a protruding pointer 604 that extends toward the focused entry 416.

FIG. 6 illustrates the scenario where the primary content 412 is the show “Chopped” and the selected program event is the show “Project Runway”, both of which are currently being broadcast. The first video presentation area 406 is used to present the show “Chopped” and the preview window 602 is used to present the video content 606 of the show “Project Runway” in real time. For this particular example, the primary content 412 is presented in the first video presentation area 406, while the preview window 602 is generated and presented in a different area of the display element. In other words, the first video presentation area 406 and the preview window 602 are displayed in distinct, separate, and non-overlapping areas of the display element. This is desirable to provide a clear and unobstructed view of the primary content 412. Similarly, the interactive EPG 402 is rendered such that the entry 416 is presented a first area of the display element, while the preview window 602 is generated and presented in a different area of the display element. Thus, the entry 416 and the preview window 602 are displayed in distinct, separate, and non-overlapping areas of the display element. This is desirable to provide a clear and unobstructed view of any information displayed within the boundary of the entry 416, such as the title of the show “Project Runway” for this particular example.

The shape, size, aspect ratio, and location of the displayed preview window 602 may change from one system to another, from one embodiment to another, and/or as needed during operation of the video services receiver. For example, the size and location of the preview window 602 may be dynamically configurable to accommodate the layout and formatting of the interactive EPG 402. Thus, the displayed location of the preview window 602 can move within the display element as the user navigates within the interactive EPG 402.

FIG. 7 is a rendering of a display screen 700 that may be rendered when a selected or focused program event in the EPG 402 is currently unavailable for presentation in the preview window. Some of the features and characteristics of the display screen 700 are similar or identical to those described above for the display screen 400 and/or for the display screen 600. For the sake of brevity and simplicity, common features and aspects will not be redundantly described here with reference to the display screen 700.

For this example, the display screen 700 includes the EPG 402 shown in FIG. 4 after the entry 418 for the upcoming show “House Hunters” has obtained focus (note that the show “House Hunters” is scheduled to be broadcast at 8:00 PM, which is some time in the near future). FIG. 7 also shows an exemplary implementation of a preview window 702 displayed in association with the entry 418. For this example, the preview window 702 includes a protruding pointer 704 that extends toward the focused entry 418.

FIG. 7 illustrates the scenario where the primary content 412 is the show “Chopped” and the selected program event is the show “House Hunters”, which is not being currently broadcast. The first video presentation area 406 is used to present the show “Chopped” and the preview window 702 is used to present secondary content in the form of a poster 706 for the show “House Hunters”. Thus, even though the actual video content for the selected program event is unavailable, the preview window 702 is still used to convey relevant content regarding the event.

FIG. 8 is a rendering of a display screen 800 that includes the EPG 502 shown in FIG. 5. The display screen 800 may be rendered after the entry 516 for the show “The Mentalist” has obtained focus. Focus of the entry 516 may be indicated by shading, coloring, highlighting, outlining, or by any technique that makes the entry 516 distinguishable from other entries. FIG. 8 also shows an exemplary implementation of a preview window 802 displayed in association with the entry 516. Although not always required, the preview window 802 may include an arrow, a line, or some other visual indicator that links the preview window 802 to the focused entry 516. For this example, the preview window 802 includes a protruding pointer 804 that extends toward the focused entry 516.

FIG. 8 illustrates the scenario where the current primary content 504 is the show “Law & Order” and the selected program event is the show “The Mentalist”, where “Law & Order” is currently being broadcast and presented on the display element (however, “The Mentalist” is currently unavailable because it will be broadcast at some time in the future). For this particular example, the primary content 504 is presented in a full screen or substantially full screen mode, while the preview window 802 is generated and presented in a manner that partially overlaps or obscures the primary content 504.

The shape, size, aspect ratio, and location of the displayed preview window 802 may change from one system to another, from one embodiment to another, and/or as needed during operation of the video services receiver. For example, the size and location of the preview window 802 may be dynamically configurable to accommodate the layout and formatting of the interactive EPG 502. Thus, the displayed location of the preview window 802 can move within the display element as the user navigates within the interactive EPG 402.

FIG. 8 illustrates the scenario where the primary content 504 is the show “Law & Order” and the selected program event is the upcoming show “The Mentalist”. The preview window 802 is used to present secondary content in the form of a poster 806 for the show “The Mentalist”. As mentioned previously, the secondary content could instead be realized as a recorded advertisement, a recorded or downloaded preview clip for the episode of “The Mentalist”, a streaming media file, a splash screen, an image or graphic related to the TNT channel, or the like. Thus, even though the actual video content for the selected program event is unavailable, the preview window 802 can still be used to convey relevant content regarding the event.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a video services receiver having a display element operatively associated therewith, the method comprising:
providing primary content for presentation on the display element;
providing an interactive electronic program guide (EPG) for presentation on the display element concurrently with presentation of the primary content, the interactive EPG comprising a plurality of entries corresponding to a plurality of listed program events;
detecting focus of one of the plurality of entries to obtain a selected program event;
generating a preview window for presentation on the display element concurrently with presentation of the primary content and concurrently with presentation of at least a portion of the interactive EPG; and
providing secondary content in the preview window, the secondary content being associated with the selected program event.

2. The method of claim 1, wherein:
the selected program event is a current broadcast event; and
providing secondary content comprises presenting video corresponding to the current broadcast event in the preview window.

3. The method of claim 1, wherein:
the selected program event is an upcoming broadcast event; and
providing secondary content comprises presenting a preview clip for the upcoming broadcast event.

4. The method of claim 1, wherein:
the selected program event is an upcoming broadcast event; and
providing secondary content comprises presenting a graphic that identifies the upcoming broadcast event.

5. The method of claim 1, wherein:
the selected program event is an upcoming broadcast event to be broadcast on a specified channel; and
providing secondary content comprises presenting a graphic that identifies the specified channel.

6. The method of claim 1, wherein:
the selected program event is an upcoming broadcast event to be broadcast by a specified network; and
providing secondary content comprises presenting a graphic that identifies the specified network.

7. The method of claim 1, wherein generating the preview window and providing the secondary content in the preview window are performed automatically in response to detecting focus of one of the plurality of entries.

8. The method of claim 1, further comprising:
receiving a user-initiated preview command for the selected program event, wherein generating the preview window and providing the secondary content in the preview window are performed in response to receiving the user-initiated preview command.

9. The method of claim 1, wherein:
providing the primary content comprises presenting a primary audio track that corresponds to the primary content; and
providing the secondary content comprises presenting a muted version of the selected program event.

10. The method of claim 9, further comprising:
receiving a user-initiated audio toggle command for the selected program event; and
in response to receiving the user-initiated audio toggle command, replacing the primary audio track with a secondary audio track that corresponds to the selected program event.

11. The method of claim 1, wherein:
providing the primary content comprises presenting the primary content in a first area of the display element;
generating the preview window comprises presenting the preview window in a second area of the display element; and
the first area of the display element and the second area of the display element are distinct, separate, and non-overlapping.

12. The method of claim 1, wherein:
providing the interactive EPG comprises presenting the one of the plurality of entries in a first area of the display element;
generating the preview window comprises presenting the preview window in a second area of the display element; and
the first area of the display element and the second area of the display element are distinct, separate, and non-overlapping.

13. A video services receiver comprising:
a receiver interface to receive data associated with video services;
a display interface for a display element operatively coupled to the video services receiver, the display interface facilitating presentation of video content on the display element; and
a processor architecture comprising at least one processor device, wherein the processor architecture cooperates with the receiver interface and the display element to:
provide primary video content for presentation in a first area of the display element;
provide an interactive electronic program guide (EPG) for presentation in a second area of the display element concurrently with the primary video content; and
generate a preview window for presentation on the display element concurrently with the interactive EPG and the primary video content, the preview window comprising secondary content that is contextually related to a selected program event in the interactive EPG.

14. The video services receiver of claim 13, further comprising a first decoder and a second decoder, wherein the first decoder decodes the primary video content, and wherein the second decoder decodes the secondary content.

15. The video services receiver of claim 13, wherein:
the selected program event is a current broadcast event; and
the secondary content comprises video corresponding to the current broadcast event.

16. The video services receiver of claim 13, wherein:
the selected program event is an upcoming broadcast event; and
the secondary content comprises a preview video for the upcoming broadcast event.

17. The video services receiver of claim 13, wherein:
the selected program event is an upcoming broadcast event; and
the secondary content comprises a graphic associated with the upcoming broadcast event.

18. A method of operating a video services receiver having a display element operatively associated therewith, the method comprising:
providing an interactive electronic program guide (EPG) for presentation on the display element, the interactive EPG comprising a plurality of entries corresponding to a plurality of listed program events;
detecting focus of one of the plurality of entries to obtain a selected program event;
generating a preview window for presentation on the display element concurrently with presentation of at least a portion of the interactive EPG; and
providing secondary content for presentation in the preview window, the secondary content being contextually related to the selected program event.

19. The method of claim 18, further comprising:
providing primary content for presentation on the display element concurrently with presentation of the secondary content in the preview window.

20. The method of claim 19, wherein:
the primary content is a first current broadcast event on a first channel received by the video services receiver;
the selected program event is a second current broadcast event on a second channel received by the video services receiver; and
providing the secondary content comprises presenting video content of the second current broadcast event in the preview window.
